(19) United States
(12) Patent Application Publication
(10) Pub. No.: US 2015/0346625 A1
(43) Pub. Date: Dec. 3, 2015

(54) EXPOSURE DEVICE, IMAGE FORMING APPARATUS AND METHOD FOR MANUFACTURING EXPOSURE DEVICE

(71) Applicant: FUJI XEROX CO., LTD., Tokyo (JP)

(72) Inventor: Sachiya Okazaki, Mie (JP)

(21) Appl. No.: 14/516,630

(22) Filed: Oct. 17, 2014

(30) Foreign Application Priority Data
Jun. 3, 2014 (JP) 2014-115161

(51) Int. Cl. B41J 2/385

(52) U.S. Cl. CPC G03G 15/043

(57) ABSTRACT

An exposure device includes: a board; a plurality of light emitting elements that are disposed on the board along a longitudinal direction of the board, each of the light emitting elements having a plurality of light emitting points arrayed along the longitudinal direction; a housing that the board and an optical element are fixed to so that the light emitting points are opposed to the optical element; and a control portion that makes control to disable, from emitting light, light emitting points at opposite ends of the board in the longitudinal direction, of all the light emitting points in the plurality of light emitting elements disposed on the board.

### CROSS-REFERENCE TO RELATED APPLICATIONS

This application is based on and claims priority under 35 USC 119 from Japanese Patent Application No. 2014-115161 filed on Jun. 3, 2014.

### BACKGROUND

### Technical Field

The present invention relates to an exposure device, an image forming apparatus and a method for manufacturing the exposure device.

### SUMMARY

According to an aspect of the invention, there is provided an exposure device including: a board; a plurality of light emitting elements that are disposed on the board along a longitudinal direction of the board, each of the light emitting elements including a plurality of light emitting points arrayed along the longitudinal direction; a housing that the board and an optical element are fixed to so that the light emitting points are opposed to the optical element; and a control portion that makes control to disable, from emitting light, light emitting points at opposite ends of the board in the longitudinal direction, of all the light emitting points in the plurality of light emitting elements disposed on the board.

### BRIEF DESCRIPTION OF THE DRAWINGS

Exemplary embodiments of the present invention will be described in detail based on the following figures, wherein:

FIG. 1 is a schematic view (front view) of an image forming apparatus according to an exemplary embodiment;

FIG. 2 is a perspective view showing a part of an exposure device constituting the image forming apparatus according to the exemplary embodiment;

FIG. 3 is a schematic view (side view) showing the relation between the exposure device and a photosensitive drum constituting the image forming apparatus according to the exemplary embodiment; and

FIG. 4 is a schematic view of light emitting elements constituting the exposure device according to the exemplary embodiment.

### REFERENCE SIGNS LIST

10 image forming apparatus
42 photosensitive drum (example of image carrier)
46 development device
50 transfer unit (example of transfer device)
52 transfer belt (example of body to be transferred)
61 printed wiring board (example of board)
62 LED array (example of light emitting element)
64 control portion
65 light emitting portion
74 LED (example of light emitting point)
80 lens array (example of optical element)
90 housing
94 external wall (example of reference of housing)
100 exposure device
M predetermined distance

### DETAILED DESCRIPTION

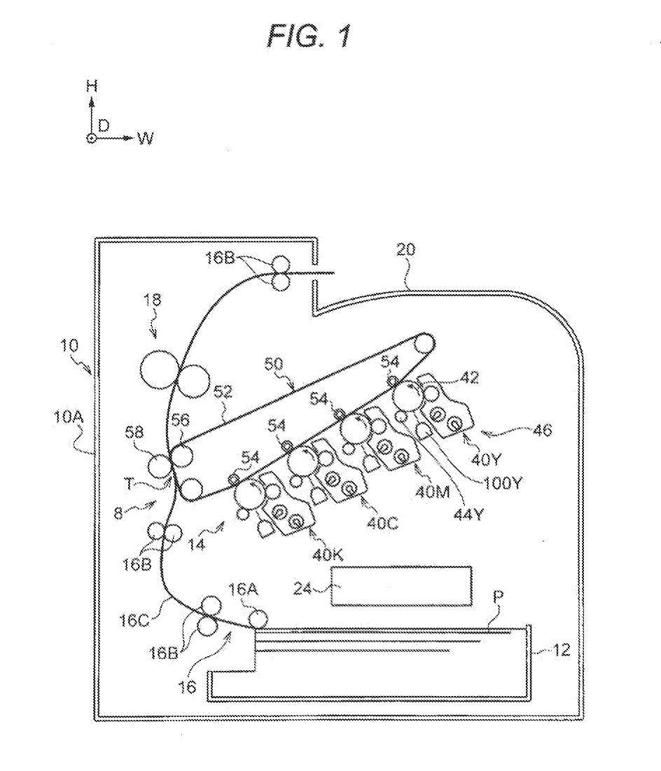

An exemplary embodiment of the invention will be described below based on the drawings. First, the overall configuration and operation of an image forming apparatus will be described. Next, an exposure device as a main part of the exemplary embodiment and a method for manufacturing the exposure device will be described. Next, effects of the exemplary embodiment will be described. Next, a modification of the exemplary embodiment will be described. In the following description, in FIG. 1, a direction indicated by an arrow H is set as an apparatus height direction and a direction indicated by an arrow W is set as an apparatus width direction. In addition, a direction (appropriately indicated by an arrow D) perpendicular to both the apparatus height direction and the apparatus width direction is set as an apparatus depth direction.

### <Overall Configuration of Image Forming Apparatus>

An image forming apparatus 10 is configured to include an image formation portion 8 and a control device 24. The image forming apparatus 10 will be described below with reference to FIG. 1.

### [Image Formation Portion]

The image formation portion 8 is provided with a medium container portion 12, a toner image formation portion 14, a conveyance portion 16, a fixation device 18, and an ejection portion 20. The image formation portion 8 is designed to form an image on a medium P. The control device 24 is designed to control operations of the respective portions of the image forming apparatus 10.

### [Toner Image Formation Portion]

The toner image formation portion 14 is provided with image formation units 40Y, 40M, 40C and 40K, and a transfer unit 50. Here, yellow (Y), magenta (M), cyan (C) and black (K) are examples of toner colors. The transfer unit 50 is an example of a transfer device.

The image formation units 40Y, 40M, 40C and 40K have substantially the same configurations except toners used therein. Reference numerals for the respective portions constituting the image formation units 40M, 40C and 40K are omitted in FIG. 1.

### <Image Formation Units>

The image formation unit 40Y is provided with a photosensitive drum 42Y, a charging device 44Y, an exposure device 100Y, and a development device 46Y. Similarly, the image formation units 40M, 40C and 40K are provided with photosensitive drums 42M, 42C and 42K, charging devices 44M, 44C and 44K, exposure devices 100M, 100C and 100K, and development devices 46M, 46C and 46K, correspondingly to the respective colors. In the following description, suffixes in the image formation units 40Y, 40M, 40C and 40K and the respective members constituting the image formation units 40Y, 40M, 40C and 40K will be omitted when it is not necessary to distinguish the colors.

### (Photosensitive Drums)

Each of the photosensitive drums 42 has a function of retaining a toner image developed by a corresponding one of the development devices 46 while rotating around its own axis. Here, the photosensitive drum 42 is an example of an image carrier.

### (Charging Devices)

Each of the charging devices 44 has a function of charging a corresponding one of the photosensitive drums 42 with static electricity.

### (Exposure Devices)

Each of the exposure devices 100 has a function of forming a latent image on a corresponding one of the photosensitive drums 42 charged with static electricity. Since the exposure device 100 serves as a main part of the exemplary embodiment, it will be described later.

### (Development Devices)

Each of the development devices 46 has a function of developing, as a toner image, the latent image formed on a corresponding one of the photosensitive drums 42.

### <Transfer Unit>

The transfer unit 50 has a function of secondarily transferring the respective color toner images onto a medium P after the toner images developed on the photosensitive drums 42 have been primarily transferred. The transfer unit 50 is provided with a transfer belt 52, a plurality of primary transfer rolls 54, a drive roll 56, and a secondary transfer roll 58. Here, the transfer belt 52 is an example of a body to be transferred.

### [Conveyance Portion and Ejection Portion]

The conveyance portion 16 has a function of conveying a medium P received in the medium container portion 12 along a conveyance path 16C and ejecting the medium P to the ejection portion 20. The conveyance portion 16 is provided with a delivery roll 16A and a plurality of conveyance roll pairs 16B.

### [Fixation Device]

The fixation device 18 has a function of pressing while heating the toner images secondarily transferred to the medium P so as to fix the toner images to the medium P.

### <Operation of Image Forming Apparatus>

Next, an operation in the image forming apparatus 10 will be described with reference to FIG. 1.

An image signal transmitted from an external apparatus (e.g. a personal computer) is converted into image data of the respective colors and outputted to the respective exposure devices 100 by the control device 24.

Successively, exposure light beams emitted from the exposure devices 100 are incident on the photosensitive drums 42 charged with static electricity by the charging devices 44 to thereby form latent images on the photosensitive drums 42 respectively. Successively, the latent images are developed as the respective color toner images by the development devices 46. Successively, the respective color toner images are primarily transferred to the transfer belt 52 by the primary transfer rolls 54.

On the other hand, a medium P is conveyed in accordance with a timing when a section of the transfer belt 52 to which the toner images have been primarily transferred reaches a nip portion T so that the toner images can be secondarily transferred from the section of the transfer belt 52 onto the medium P in the nip portion T.

Successively, the medium P to which the toner images have been secondarily transferred is conveyed toward the fixation device 18 so that the toner images can be fixed to the medium P by the fixation device 18.

The medium P to which the toner images have been fixed is ejected to the ejection portion 20. In this manner, an image forming operation is completed.

### <Configuration of Main Part (Exposure Device)>

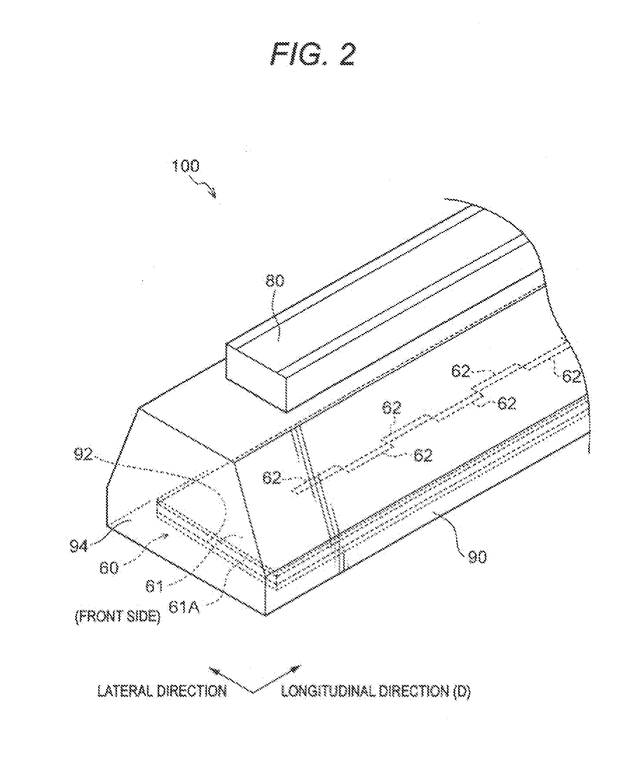

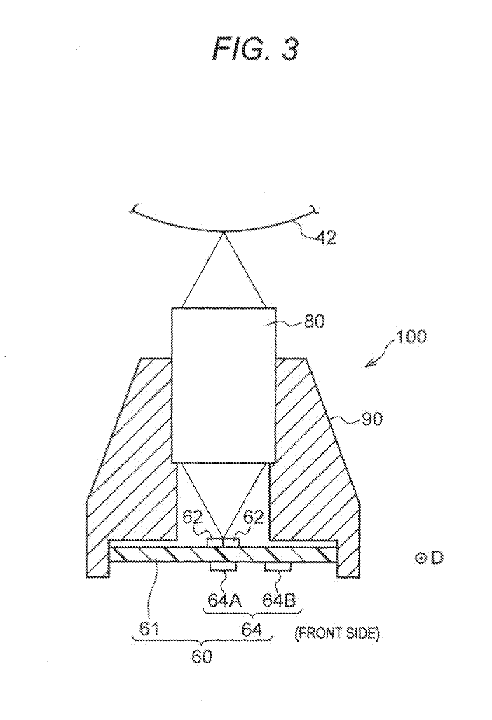

Next, the exposure device 100 as the main part of the exemplary embodiment will be described with reference to the drawings. The exposure device 100 is configured to include a light emitting board 60, a lens array 80, and a housing 90, as shown in FIG. 2 and FIG. 3. Here, the lens array 80 is an example of an optical element. Incidentally, the exposure device 100 is detachably attached to an image forming apparatus body 10A.

### [Light Emitting Board]

The light emitting board 60 has a function of emitting light from a plurality of LEDs (light emitting diodes) 74 toward the lens array 80 based on the image data converted by the control device 24. The LEDs 74 will be described later. Here, the LEDs 74 are examples of light emitting points.

The light emitting board 60 is configured to include a printed wiring board 61 (hereinafter referred to as board 61), a light emitting portion 65, and a control portion 64, as shown in FIG. 2. Here, LED arrays 62 are examples of light emitting elements.

### [Printed Wiring Board and Light Emitting Portion]

The board 61 is shaped like a long plate. Here, the board 61 is an example of a board. The light emitting portion 65 is provided in an upper surface (a surface facing the photosensitive drum 42) of the board 61. The light emitting portion 65 is constituted by a plurality of LED arrays 62. The plurality of LED arrays 62 are disposed zigzag along a longitudinal direction of the board 61 on the upper surface of the board 61. In addition, a plurality of LEDs 74 are arrayed linearly (along in an array direction of the plurality of LEDs 74) along the longitudinal direction of the board 61 in each of the LED arrays 62. Incidentally, in the exemplary embodiment, the number of LED arrays 62 is 20 and the number of LEDs 74 disposed on each of the LED arrays 62 is 508, by way of example.

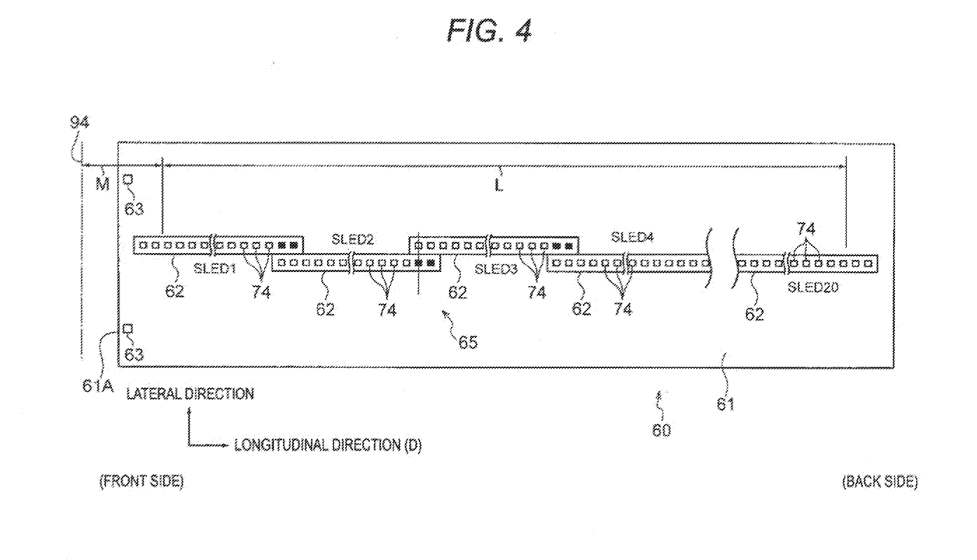

The LED arrays 62 are designated by SLED1, SLED2, SLED3, SLED4, . . . and SLED20 counted from one end side (front side in the apparatus depth direction, hereinafter referred to as front side) of the board 61 in the longitudinal direction in FIG. 4. Two LEDs 74 in each of the LED array 62 overlap with two LEDs 74 in another adjacently disposed LED array 62 in a lateral direction of the board 61. Of the LEDs 74 constituting each of the LED arrays 62 except the SLED20, two LEDs 74 (LEDs 74 colored in black in FIG. 4) counted from an end portion on the other end side (back side in the apparatus depth direction, hereinafter referred to as back side) of the board 61 in the longitudinal direction are set to be disabled from emitting light.

An LED 74 in the front-side end portion is disposed on the front side of a front-side end portion of a maximum image formation region L of the photosensitive drum 42. In addition, an LED 74 in the back-side end portion is disposed on the back side of a back-side end portion of the maximum image formation region L of the photosensitive drum 42. In the exemplary embodiment, the LEDs 74 disposed outside (on the front side or the back side of) the opposite ends of the maximum image formation region L are set to be disabled from emitting light during image formation. Here, the maximum image formation region L of the photosensitive drum 42 means a range where a toner image can be formed on the photosensitive drum 42 in an axis direction of the photosensitive drum 42. Therefore, it is necessary to align a maximum exposure region of the exposure device 100 (a range where the exposure device 100 can actually form an image of light on the photosensitive drum 42 in the axis direction of the photosensitive drum 42) with the maximum image formation region L of the photosensitive drum 42 within an error range. Incidentally, a setting method for disabling the LEDs 74 disposed outside the opposite ends of the maximum image formation region L from emitting light (hereinafter referred to as setting of non-light-emitting LEDs) will be described later.

### [Control Portion]

The control portion 64 has two functions which will be described as follows.

The first function is to make control to disable, of all the LEDs 74 in the LED arrays 62 disposed on the board 61, the LEDs 74 in the opposite ends of the board 61 in the longitudinal direction from emitting light. Specifically, the control portion 64 makes control to disable one or more LEDs 74 in the front-side end portion of the board 61 in the SLED1 from emitting light during image formation. Further, the control portion 64 makes control to disable one or more LEDs 74 counted from the back-side end portion of the board 61 in the SLED20 from emitting light during image formation.

The second function is to disable, of all the LEDs 74 constituting the LED arrays 62 except the SLED20, two LEDs 74 counted from the back-side end portion of each of the LED arrays 62 from emitting light.

As shown in FIG. 3, the control portion 64 is configured to include an ROM (nonvolatile memory) 64A and a driver IC 64B. The ROM 64A and the driver IC 64B are disposed on a lower surface of the board 61. Incidentally, the ROM 64A in the exemplary embodiment is set as an EPROM by way of example. Position information (addresses) of the LEDs 74 which are set to be disabled from emitting light during image formation is written into the ROM 64A. The driver IC 64B is designed not to apply a voltage to input terminals (not shown) of the LEDs 74 disposed outside the opposite ends of the maximum image formation region L during image formation based on the position information written in the ROM 64A. Incidentally, a plurality of output terminals (not shown) outputting a voltage are provided in the IC driver 648. The output terminals of the IC driver 648 are connected to the input terminals of the LEDs 74 by wiring (not shown)

### [Supplement on Light Emitting Board]

Although the configuration of the light emitting board 60 has been described above, the light emitting board 60 according to the exemplary embodiment is formed as a so-called multilayer board in which multiple printed wiring substrates are laminated in multiple layers. Connectors (not shown) etc. in addition to the aforementioned ROM 64A are disposed on the lower surface of the board 61. Moreover, as shown in FIG. 4, a pair of marks 63 are placed on the front side in the upper surface of the board 61. The pair of marks 63 are used as positioning marks when the LEDs 62 are disposed on the upper surface of the board 61.

### [Lens Array]

The lens array 80 has a function of forming an image of light emitted from the plurality of LEDs 74 on the photosensitive drum 42.

The lens array 80 is long and formed as a SELFFOC (registered trademark) lens array which is an assembly of a plurality of rod lenses. As shown in FIG. 3, the lens array 80 is disposed between the board 61 and the photosensitive drum 41 in the image forming apparatus 10.

### [Housing]

The housing 90 has a function of fixing the light emitting board 60 (board 61) and the lens array 80 so as to oppose the plurality of LEDs 74 in the light emitting board 60 to the lens array 80, as shown in FIG. 2 and FIG. 3.

The housing 90 is long and disposed so that the longitudinal direction of the house 90 is in line with the axis direction of the photosensitive drum 42. In addition, a long through hole is formed in the housing 90 along the axis direction of the photosensitive drum 42 to face the photosensitive drum 42.

In the housing 90, the lens array 80 is fixed to a peripheral edge of an opening portion on the photosensitive drum 42 side in the long through hole so that the longitudinal direction of the lens array 80 is in line with the apparatus depth direction of the image forming apparatus 10. In addition, in the housing 90, the light emitting board 60 is fixed in a state in which the longitudinal direction of the light emitting board 60 is in line with the longitudinal direction of the lens array 80 and the light emitting board 60 covers an opposite opening portion to the opening portion on the photosensitive drum 42 side, as shown in FIG. 2 and FIG. 3. In this case, an end surface 61A of the light emitting board 60 in the longitudinal direction abuts against a front-side inner wall (hereinafter referred to as inner wall 92) of inner walls formed by the long through hole of the housing 90. The light emitting board 60 and the lens array 80 are fixed in the housing 90 with predetermined accuracy.

Incidentally, the housing 90 is positioned in the image forming apparatus body 10A with reference to a front-side outer wall 94 in the housing 90. Therefore, even when the exposure device 100 is not attached to the image forming apparatus body 10A, the position relation between the LEDs 74 and the maximum image formation region L along the longitudinal direction of the board 61 from the outer wall 94 can be grasped. Here, the outer wall 94 is an example of a reference on the side of the housing 90 where the board 61 abuts against the housing 90.

### <Method for Manufacturing Exposure Device>

Next, a method for manufacturing the exposure device 100 will be described with reference to the drawings. The method for manufacturing the exposure device 100 includes a first step, a second step, and a third step.

### [First Step]

In the first step, the plurality of LED arrays 62 are disposed on the board 61 to make the longitudinal directions of the LED arrays 62 in line with the longitudinal direction of the board 61.

Specifically, in the first step, the LED arrays 62 are disposed zigzag on the upper surface of the board 61 to make the longitudinal directions of the LED arrays 62 in line with the longitudinal direction of the board 61, as shown in FIG. 2 and FIG. 4. On this occasion, the plurality of LED arrays 62 are disposed so that two LEDs 74 in each LED array 62 can overlap with two LEDs 74 in another adjacently disposed LED array 62 in the lateral direction of the board 61, as shown in FIG. 4. Further, the distance between the LED 74 in the front-side end portion of the board 61 and the LED 74 in the back-side end portion of the board 61 is wider than the width of the maximum image formation region L.

In addition, in the first step, the ROM 64A, the driver IC 648, the connectors, etc. are disposed on the lower surface of the board 61. When the first step is completed, assembling of the light emitting board 60 is completed.

### [Second Step]

In the second step, the light emitting board 60 and the lens array 80 are fixed to the housing 90 so that the plurality of LEDs 74 are opposed to the lens array 80 in a state in which one end of the light emitting board 60 in the longitudinal direction abuts against the housing 90, as shown in FIG. 2.

Specifically, in the second step, the end surface 61A of the board 61 is made to abut against the inner wall 92 of the housing 90 to thereby fix the light emitting board 60 to the housing 90. When the second step is completed, assembling of an assembly (hereinafter referred to as assembly) in which the light emitting board 60 and the lens array 80 are fixed to the housing 90 is completed.

### [Third Step]

In the third step, setting (setting of non-light-emitting LEDs) is made in the control portion 64 so that, with a reference on a side of the house 90 where the board 61 abuts against the housing 90, LEDs 74 closer to the reference than a site located at a predetermined distance M along the longitudinal direction of the board 61 from the reference can be disabled from emitting light. Here, the predetermined distance from the reference along the longitudinal direction of the board 61 is a distance between the external wall 94 and the front-side end portion of the maximum image formation region L.

Specifically, measurement of light emission positions of the LEDs 74 is performed on the assembly in the third step. The light emission positions are measured after the assembly has been attached to a light emission position measurement device (not shown). Here, on assumption that the assembly has been attached to the image forming apparatus body 10A, the measurement device can measure a distance between the external wall 94 of the housing 90 to each LED 74 emitting light to be focused on the photosensitive drum 42 (hereinafter referred to as LED distance).

Based on the measurement of the light emission positions, the LED 74 emitting light to be focused within an error range of the front-side end portion of the maximum image formation region L can be identified as an n-th (n is an integer not smaller than 1) (n-th position information) LED 74 counted from the end surface 61A of the board 61, of the LEDs 74 constituting the SLED1 (measurement of an L position of the SLED1). Based on the measurement result of the L position of the SLED1, the light emission positions are written into the ROM 64A so that the first LED 74 up to the (n−1)th LED 74 counted from the end surface 61A of the board 61 can be disabled from emitting light.

In addition, in accordance with the measurement of the L position of the SLED1, the LED 74 emitting light to be focused in the back-side end portion of the maximum image formation region L is derived as an m-th (m is an integer not smaller than 1) LED 74 counted from the opposite side to the end surface 61A of the board 61, of the LEDs 74 constituting the SLED20 (derivation of an L position of the SLED20). Based on the derivation result of the L position of the SLED20, the light emission positions are written into the ROM 64A so that the first LED 74 up to the (m−1)th LED 74 counted from the opposite side to the end surface 61A of the board 61 can be disabled from emitting light.

As described above, the position information of the LEDs 74 which are set to be disabled from emitting light is written into the ROM 64A and the driver IC 64B is designed not to apply a voltage to the input terminals of the LEDs 74 which are set to be disabled from emitting light. Accordingly, setting is made in the control portion 64 so that the LEDs 74 disposed outside the opposite ends of the maximum image formation region L can be disabled from emitting light. When the third step is completed, the exposure device 100 is completed.

### <Effects>

Next, effects of the exposure device 100, the image forming apparatus 10 and the method for manufacturing the exposure device 100 according to the exemplary embodiment will be described with reference to the drawings. In the following description, the exemplary embodiment and a comparison example assumed as follows will be compared with each other. Incidentally, when components etc. used in the exemplary embodiment are also used in the following comparison example, the components etc. are given the same reference numerals in the description. In addition, in the following description about the configuration of the comparison example, only different points from the exemplary embodiment will be described.

In an exposure device according to the comparison example, a light emitting board 60 is fixed to a housing 90 so that, of LEDs 74 disposed on the light emitting board 60, an LED 74 in a front-side end portion can be positioned within an error range of a front-side end portion of a maximum image formation region L. An image forming apparatus according to the comparison example is provided with the exposure device according to the comparison example.

In addition, a method for manufacturing the exposure device according to the comparison example has a step of fixing the light emitting board 60 to the housing 90, in which step positioning between the light emitting board 60 and the housing 90 is performed by use of marks 63 placed on an upper surface of a board 61 and an assembly is assembled. In the method for manufacturing the exposure device according to the comparison example, an inspection step is then performed in place the third step. In the inspection step, inspection is performed as to whether, of the LEDs 74 disposed on the light emitting board 60, the LED 74 in the front-side end portion is located within the error range of the front-side end portion of the maximum image formation region L or not. As a result of the inspection, the assembly approved in the inspection step of the comparison example is qualified as an exposure device.

In the exposure device according to the comparison example, as described above, the light emitting board 60 is fixed to the housing 90 so that, of the LEDs 74 disposed on the light emitting board 60, the LED 74 in the front-side end portion can be positioned within the error range of the front-side end portion of the maximum image formation region L. In other words, it is necessary to fix the light emitting board 60 to the housing 90 so that the LED 74 in the front-side end portion can be positioned within the error range of the front-side end portion of the maximum image formation region L.

On the other hand, in the exposure device 100 according to the exemplary embodiment, control is made to disable the LEDs 74 disposed outside the opposite end portions of the maximum image formation region L, from emitting light during image formation. Incidentally, position information about the LEDs 74 set to disabled from emitting light is written into the ROM 64A in the third step. Therefore, in the exposure device 100 according to the exemplary embodiment, it is not necessary to fix the light emitting board 60 to the housing 90 but the LED 74 in the front-side end portion disposed on the light emitting board 60 still can be positioned within the error range of the front-side end portion of the maximum image formation region L.

Accordingly, the exposure device 100 according to the exemplary embodiment can suppress displacement of the end portion of the maximum exposure region with respect to the end portion of the maximum image formation region L even when the position accuracy of the board 61 relative to the housing 90 is made low, in comparison with the exposure device according to the comparison example.

In accordance with this, the image forming apparatus 10 provided with the exposure device 100 according to the exemplary embodiment can suppress an image formation failure caused by the displacement of the end portion of the maximum exposure region with respect to the end portion of the maximum image formation region L, in comparison with the image forming apparatus according to the comparison example.

Incidentally, when the LEDs 74 which have been set to be disabled from emitting light in the exposure device 100 removed from the image forming apparatus 10 are reset to match a maximum image formation region L of another image forming apparatus, the reset exposure device 100 can be reused in the other image forming apparatus.

In addition, as described above, the method for manufacturing the exposure device according to the comparison example has the step of fixing the light emitting board 60 to the housing 90, in which step positioning between the light emitting board 60 and the housing 90 is performed by use of the marks 63 placed on the upper surface of the board 61 and the assembly is assembled. Therefore, in the assembly in the comparison example, the position where the light emitting board 60 is fixed to the housing 90 varies due to tolerances of the positions of the marks 63. When the LED 74 in the front-side end portion of the light emitting board 60 is not located within the error range of the front-side end portion of the maximum image formation region L in the step of fixing the light emitting board 60 to the housing 90, the assembly cannot be used as an exposure device but is a defective product.

On the other hand, the method for manufacturing the exposure device 100 according to the exemplary embodiment includes the aforementioned second step and the aforementioned third step. In the second step, the light emitting board 60 is fixed to the housing 90 in the state in which the end surface 61A of the board 61 is made to abut against the inner wall 92 of the housing 90 and the positions of the LEDs 74 disposed in the one end and the other end of the board 61 in the longitudinal direction are located outside the maximum image formation region L. Then, in the third step, the position information of the LEDs 74 disposed outside the opposite end portions of the maximum image formation region L are written into the ROM 64A so that the LEDs 74 disposed outside the opposite end portions of the maximum image formation region L can be disabled from emitting light during image formation.

Therefore, the method for manufacturing the exposure device 100 according to the exemplary embodiment can adjust the LEDs 74 set to be enabled to emit light in the opposite ends of the maximum image formation region L even when the position accuracy of the light emitting board 60 relative to the housing 90 is low, in comparison with the step of fixing the light emitting board 60 to the housing 90 according to the comparison example. In other words, the assembly is rarely a defective product in the method for manufacturing the exposure device 100 according to the exemplary embodiment.

Accordingly, the method for manufacturing the exposure device 100 according to the exemplary embodiment can improve the productivity of the exposure device 100, in comparison with the method for manufacturing the exposure device according to the comparison example.

### <Modification of Exemplary Embodiment>

Next, a modification of the exemplary embodiment (a method for manufacturing the exposure device 100) will be described.

In the modification, when the maximum exposure region of the exposure device 100 with respect to the maximum image formation region is beyond the error range after the image forming apparatus 10 is in use, the LEDs 74 which have been set to be disabled from emitting light can be reset in the control portion 64. It may be considered that the maximum exposure region of the exposure device 100 with respect to the maximum image formation region L is beyond the error range, for example, when the lens array 80 is deformed due to the use of the exposure device 100 or when the image forming apparatus 10 is vibrated due to an earthquake or the like.

The LEDs 74 emitting light to be focused on the opposite ends of the maximum image formation region L can be measured, for example, based on observation of a toner image which has been developed on the photosensitive drum 42 and then primarily transferred to the transfer belt 52. Based on the measurement result, the LEDs 74 which are disabled from emitting light can be reset. The method for manufacturing the exposure device 100 according to the modification is the same as the method for manufacturing the exposure device 100 according to the exemplary embodiment except this point.

As described above, the position information of the LEDs 74 set to be disabled from emitting light are written into the ROM 64A on the assumption that the position relation between the maximum image formation region L and the LEDs 74 with reference to the outer wall 94 of the housing 90 is grasped in the third step of the exemplary embodiment. Therefore, when the exposure device 100 is attached to the image forming apparatus body 10A, there is a fear that the maximum exposure region of the exposure device 100 may overlap with the maximum image formation region L of the photosensitive drum 42 beyond the error range.

However, according to the method for manufacturing the exposure device 100 according to the modification, after the exposure device 100 has been attached to the image-forming apparatus body 10A, setting can be made again in the control device 64 so that the maximum exposure region of the exposure device 100 can align with the maximum image formation region L of the photosensitive drum 42 within the error range.

Accordingly, the method for manufacturing the exposure device 100 according to the modification can suppress an image formation failure caused by variation of attachment accuracy of the exposure device 100 to the image forming apparatus body 10A, in comparison with the case where setting cannot be made again. Particularly in the case where image formation units 40 for four colors are provided as in the image forming apparatus 10 according to the exemplary embodiment, the method for manufacturing the exposure device 100 according to the modification is effective in adjusting the maximum exposure region in each of the exposure devices 100.

Although the invention has been described above in detail regarding a specific exemplary embodiment, the invention is not limited to the aforementioned exemplary embodiment but may include any other exemplary embodiment within the scope of the technical ideas of the invention.

For example, the exemplary embodiment has been described in the case where the plurality of LED arrays 62 are disposed zigzag along the longitudinal direction of the board 61 on the upper surface of the board 61. However, the plurality of LED arrays 62 do not have to be disposed zigzag as long as the LED arrays 62 are disposed along the longitudinal direction of the board 61.

In addition, the exemplary embodiment has been described in the case where two LEDs 74 in each LED array 62 overlap with two LEDs 74 in another adjacently disposed LED array 62 in the lateral direction of the board 61. However, the two LEDs 74 do not have to be disposed to overlap in the aforementioned manner in the lateral direction of the board 61 as long as the plurality of LED arrays 62 are disposed along the longitudinal direction of the board 61.

In addition, the exemplary embodiment has been described in the case where the number of LED arrays 62 disposed on the board 61 is 20 and the number of LEDs 74 disposed on each LED array 62 is 508 by way of example. However, the number of LED arrays 62 does not have to be 20 and the number of LEDs 74 disposed on each LED array 62 does not have to be 508 as long as the distance between the LEDs 74 disposed in the opposite ends of the board 61 in the longitudinal direction is wider than the width of the maximum image formation region L.

In addition, the exemplary embodiment has been described in the case where the ROM 64A, the driver IC 64B, the connectors etc. (hereinafter referred to as lower surface components etc.) are disposed on the lower surface of the board 61 in the first step. However, the step of disposing the lower surface components etc. on the lower surface of the board 61 may be performed in a step before or after the first step as long as the lower surface components etc. are disposed on the lower surface of the board 61 before the second step.

In addition, the exemplary embodiment has been described in the case where the reference of the housing 90 is set as the outer wall 94 in the housing 90 in the third step. However, the reference of the housing 90 does not have to be the outer wall 94. For example, the reference of the housing 90 may be any other section of the housing 90. In addition, in the case where the housing 90 is attached to the image forming apparatus body 10A, an assembly in which the housing 90 is fixed to a plate member having a positioning member such as a pin may be regarded as the housing so that the positioning member such as the pin can be set as the reference of the housing 90.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. An exposure device comprising:
a board;
a plurality of light emitting elements that are disposed on the board along a longitudinal direction of the board, each of the light emitting elements comprising a plurality of light emitting points arrayed along the longitudinal direction;
a housing that the board and an optical element are fixed to so that the light emitting points are opposed to the optical element; and
a control portion that makes control to disable, from emitting light, light emitting points at opposite ends of the board in the longitudinal direction, of all the light emitting points in the plurality of light emitting elements disposed on the board.

2. An exposure device comprising:
a board;
an optical element;
a housing that the board and the optical element are fixed to so that the board is opposed to the optical element; and
a light emitting portion that comprises light emitting elements each comprising a linear array of a plurality of light emitting points, the light emitting elements being disposed on the board along a longitudinal direction of the board, the light emitting points at opposite ends of the board in the longitudinal direction being set to be disabled from emitting light.

3. An image forming apparatus comprising:
the exposure device according to claim 1;
an image carrier that is exposed to light by the exposure device so that a latent image is formed on the image carrier;
a development device that develops, as a toner image, the latent image formed on the image carrier; and
a transfer device that transfers the toner image developed by the development device to a body to be transferred.

4. An image forming apparatus comprising:
the exposure device according to claim 2;
an image carrier that is exposed to light by the exposure device so that a latent image is formed on the image carrier;
a development device that develops, as a toner image, the latent image formed on the image carrier; and
a transfer device that transfers the toner image developed by the development device to a body to be transferred.

5. A method for manufacturing an exposure device, comprising:
disposing, on a board, a plurality of light emitting elements each having a linear array of a plurality of light emitting points so that the light emitting elements are disposed on the board along a longitudinal direction of the board;
fixing the board and an optical element to a housing so as to oppose the light emitting points to the optical element in a state in which one end of the board in the longitudinal direction is made to abut against the housing; and
disabling, from emitting light, the light emitting points that are closer to a reference than a site that is at a predetermined distance from the reference in the longitudinal direction, the reference being on a side of the housing where the board abuts against the housing.
